(19) United States
(12) Patent Application Publication
(10) Pub. No.: US 2026/0061993 A1
(43) Pub. Date: Mar. 5, 2026

(54) AUTOMATED VALET PARKING SYSTEM AND AUTOMATED VALET PARKING METHOD

(71) Applicant: TOYOTA JIDOSHA KABUSHIKI KAISHA, Toyota-shi (JP)

(72) Inventor: Amane YAJIMA, Ashigarakami-gun (JP)

(73) Assignee: TOYOTA JIDOSHA KABUSHIKI KAISHA, Toyota-shi (JP)

(21) Appl. No.: 19/308,134

(22) Filed: Aug. 22, 2025

(30) Foreign Application Priority Data
Aug. 29, 2024 (JP) 2024-147519

(51) Int. Cl. B60W 30/06; B60W 30/14; B60W 60/00

(52) U.S. Cl. CPC B60W 30/06; B60W 30/146; B60W 60/001; B60W 2520/10; B60W 2720/10

(57) ABSTRACT

A system includes a management device configured to manage automated valet parking, and a control device configured to perform vehicle control for the automated valet parking. The vehicle control includes processing of applying an upper limit guard. The processing of applying the upper limit guard includes processing of determining whether or not a first distance from a target position of a target path point to a target position of a path end point is equal to or less than a guard threshold, and processing of replacing the maximum speed of the target path point by using a minimum speed between a guard speed and a maximum speed included in each of the plurality of path points included in a traveling path in a case where the first distance is determined to be equal to or less than the guard threshold.

### CROSS-REFERENCE TO RELATED APPLICATION

This application claims priority to Japanese Patent Application No. 2024-147519 filed on Aug. 29, 2024. The disclosure of the above-identified application, including the specification, drawings, and claims, is incorporated by reference herein in its entirety.

### BACKGROUND

### 1. Technical Field

The present disclosure relates to an automated valet parking (AVP) system of a vehicle within a predetermined area such as a parking area, and an automated valet parking method.

### 2. Description of Related Art

Japanese Patent No. 6756828 (JP 6756828 B) discloses a method for guiding a vehicle within a parking area. In this guiding method, an external device specifies a traveling path for remotely controlling a vehicle to be guided and transmits the traveling path to the vehicle to be guided. Further, in the guiding method, the external device monitors deviation from the traveling path of the vehicle to be guided that autonomously travels within a parking area based on the traveling path.

### SUMMARY

While not specifically mentioned in JP 6756828 B, as information included in the traveling path, position information and maximum speed information are conceivable. The position information is information indicating a position through which the vehicle to be guided should pass within the parking area and is, for example, provided as a two-dimensional coordinate. The maximum speed information is information indicating a maximum speed (upper limit speed) with which the vehicle to be guided should comply.

The maximum speed can be changed in accordance with a position of the traveling path, a traveling situation of the vehicle to be guided, and the like. For example, a maximum speed of a traveling path for linear passage can be set higher than a maximum speed of a traveling path for curved passage. Further, a maximum speed in a case where a distance from the vehicle to be guided to an obstacle (for example, another vehicle, a structure) is short is set lower than a maximum speed in a case where a distance to the obstacle is long.

In a case where the maximum speed is changed from a low speed to a high speed, an arrival time to a final destination (a parking position upon loading, a pick-up and drop-off position upon unloading) within the parking area can be shortened. However, if such a change of the maximum speed is performed at a location close to the final destination, accurate stop at the final destination becomes difficult.

The present disclosure provides a technology capable of preventing degradation in accuracy of stop at a final destination of a vehicle in a case where automated valet parking of the vehicle is performed by a traveling path including maximum speed information being received from an external device.

A first aspect of the present disclosure is a system that performs automated valet parking of a vehicle within a predetermined area. The system includes a management device configured to manage the automated valet parking, and a control device mounted on the vehicle and configured to perform vehicle control for the automated valet parking based on a traveling path received from the management device. The traveling path includes a plurality of path points. Each of the plurality of path points includes information on a target position of the vehicle, and information on a maximum speed of the vehicle. The vehicle control includes processing of applying an upper limit guard to a maximum speed of a target path point based on information on a target position of a path end point and information on a target position of the target path point. The path end point is included in the plurality of path points and indicates an end point of the traveling path. The target path point is included in the plurality of path points. The processing of applying the upper limit guard includes processing of determining whether or not a first distance from the target position of the target path point to the target position of the path end point is equal to or less than a guard threshold, and processing of replacing, by using a minimum speed between a guard speed set in advance and the maximum speed included in each of the plurality of path points, the maximum speed of the target path point in a case where the first distance is determined to be equal to or less than the guard threshold.

In the system according to the first aspect of the present disclosure, the processing of applying the upper limit guard may be performed on the target path point included in a latest traveling path received from the management device. The processing of applying the upper limit guard may further include processing of determining whether or not a second distance from a current position of the vehicle to the target position of the target path point is equal to or less than a hunting threshold. In a case where the second distance is determined to be equal to or less than the hunting threshold, in the processing of replacing the maximum speed of the target path point, the maximum speed of the target path point may be replaced by using a minimum speed among the guard speed, the maximum speed included in each of the plurality of path points, and the upper limit guard used to replace the maximum speed of the target path point included in the previous traveling path received from the management device before the latest traveling path is received.

In the system according to the first aspect of the present disclosure, the target position of the path end point may include a final destination of the vehicle within the predetermined area.

A second aspect of the present disclosure is a method for performing automated valet parking of a vehicle within a predetermined area. The method includes receiving, by a control device of the vehicle, a traveling path from a management device configured to manage the automated valet parking, and performing by the control device, vehicle control for the automated valet parking based on the traveling path. The traveling path includes a plurality of path points. Each of the plurality of path points includes information on a target position of the vehicle and information on a maximum speed of the vehicle. The vehicle control includes application of an upper limit guard to a maximum speed of a target path point based on information on a target position of a path end point and information on a target position of the target path point. The path end point is included in the plurality of path points and indicates an end point of the traveling path. The target path point is included in the plurality of path points. The application of the upper limit guard includes determining whether or not a first distance from the target position of the target path point to the target position of the path end point is equal to or less than a guard threshold, and replacing, using a minimum speed between a guard speed set in advance and the maximum speed included in each of the plurality of path points, the maximum speed of the target path point in a case where the first distance is determined to be equal to or less than the guard threshold.

In the method according to the second aspect of the present disclosure, the application of the upper limit guard may be performed on the target path point included in a latest traveling path received from the management device. The application of the upper limit guard may further include determining whether or not a second distance from a current position of the vehicle to the target position of the target path point is equal to or less than a hunting threshold. In a case where the second distance is determined to be equal to or less than the hunting threshold, in replacing the maximum speed of the target path point, the maximum speed of the target path point may be replaced using a minimum speed among the guard speed, the maximum speed included in each of the plurality of path points, and the upper limit guard used to replace the maximum speed of the target path point included in a previous traveling path received from the management device before the latest traveling path is received.

In the method according to the second aspect of the present disclosure, the target position of the path end point may include a final destination of the vehicle within the predetermined area.

According to the first aspect or the second aspect, it is determined whether or not a distance from the target position of the target path point to the target position of the path end point is equal to or less than the guard threshold. Further, in a case where this distance is determined to be equal to or less than the guard threshold, the maximum speed of the target path point is replaced using the minimum speed between the guard speed set in advance and the maximum speed of the vehicle included in each of the plurality of path points. As a result of this replacement being performed, the upper limit guard is applied to the target path point. It is therefore possible to prevent degradation of accuracy of stop of the vehicle at the path end point. In a case where the target position of the path end point is a final destination of the vehicle, it is also possible to prevent degradation of accuracy of stop of the vehicle at this final destination.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a configuration example of an automated valet parking system;

FIG. 2 is a view illustrating a configuration example of a vehicle system;

FIG. 3 is a view for explaining an example of a traveling path;

FIG. 4 is a view for explaining a problem near a stop position of a vehicle;

FIG. 5 is a view for explaining a problem near the stop position of the vehicle;

FIG. 6 is a view for explaining upper limit guard processing;

FIG. 7 is a flowchart indicating a processing example particularly related to an embodiment; and

FIG. 8 is a flowchart indicating a processing example particularly related to the embodiment.

### DETAILED DESCRIPTION OF EMBODIMENTS

An embodiment of the present disclosure will be described below with reference to the drawings. Note that in the respective drawings, the same or corresponding portions are denoted by the same reference numerals, and description thereof will be simplified or omitted.

### 1. Overall Configuration Example of System

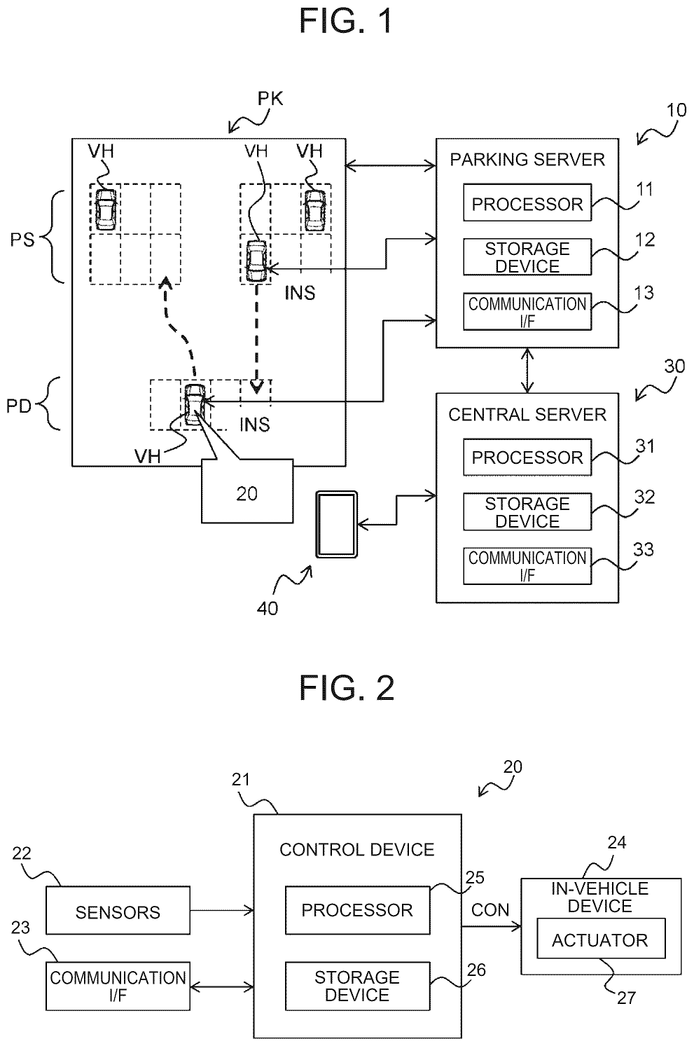

An AVP system is a system that automatically performs parking operation of a vehicle within a predetermined area such as a parking area, a factory and a facility. FIG. 1 is a view illustrating a configuration example of the AVP system. FIG. 1 illustrates a parking area PK as the predetermined area. The parking area PK has a configuration in which AVP can be executed. The configuration in which AVP can be executed includes a pick-up and drop-off space PD and a parking space PS. The pick-up and drop-off space PD is a space for getting off a vehicle VH and/or getting on the vehicle VH. The parking space PS is a space for parking the vehicle VH. The configuration in which AVP can be executed also includes a marker that assists movement of the vehicle VH within the parking area PK, sensors (for example, a camera, a radar) that monitor the vehicle VH, and the like. The vehicle VH may be an autonomous vehicle.

FIG. 1 illustrates a management server (hereinafter, also referred to as a “parking server”) 10 that manages the AVP in the parking area PK. The parking server 10 is a component corresponding to a “management device” of the present disclosure. The parking server 10 performs various kinds of processing regarding management of reservation of the AVP in the parking area PK. The parking server 10 also performs various kinds of processing regarding management of authority of operation of the vehicle VH necessary for AVP in the parking area PK. The parking server 10 further acquires various kinds of information from the sensors in the parking area PK and performs various kinds of processing regarding execution of the AVP in the parking area PK based on the various kinds of information. The parking server 10 may be a combination of a server (local server) that performs various kinds of processing regarding execution of the AVP and a server (cloud server) that performs various kinds of processing regarding management of the AVP.

The parking server 10 is typically a computer including at least one processor 11, at least one storage device 12, and a communication interface (I/F) 13. The processor 11 executes various kinds of processing. Examples of the processor 11 can include a central processing unit (CPU), a graphics processing unit (GPU), an application specific integrated circuit (ASIC), and a field-programmable gate array (FPGA). The processor 11 can be also referred to as a “circuitry” or a “processing circuitry”. The “circuitry” is hardware programmed to implement described functions or hardware that executes functions. The processor 11 reads various kinds of information from the storage device 12 and stores various kinds of information in the storage device 12.

Examples of the storage device 12 can include a volatile memory, a non-volatile memory, a hard disk drive (HDD), and a solid state drive (SSD). Examples of various kinds of information stored in the storage device 12 include parking area map information, parking area usage information, and vehicle management information. The parking area map information indicates map information of the parking area PK. The parking area usage information is information regarding a usage situation (availability information) of the pick-up and drop-off space PD and the parking space PS within the parking area PK. The vehicle management information includes information on a vehicle ID, loading and unloading time, a vehicle position, and the like. The vehicle management information is managed for each vehicle VH. The vehicle ID is identification information of the vehicle VH. The loading and unloading time is information regarding time (such as, for example, reserved time and actual time) of loading and unloading of the vehicle VH. The vehicle position indicates information regarding a position of the vehicle VH within the parking area PK.

The communication I/F 13 is an interface for communicating with a device outside the parking server 10 to transmit/receive information. For example, the communication I/F 13 includes equipment for connecting to a peripheral device through wireless LAN, equipment for connecting to a mobile communication network, equipment for connecting to the Internet, and the like. The parking server 10 transmits/receives information to/from the vehicle VH (vehicle system 20) via the communication I/F 13. The parking server 10 further transmits/receives information to/from a central server 30 via the communication I/F 13.

FIG. 2 is a view illustrating a configuration example of the vehicle system 20. In the example illustrated in FIG. 2, the vehicle system 20 is mounted on each vehicle VH as a system capable of executing the AVP. In the example illustrated in FIG. 2, the vehicle system 20 includes a control device 21, sensors 22, a communication I/F 23 and an in-vehicle device 24.

The control device 21 is communicably connected to the sensors 22, the communication I/F 23 and the in-vehicle device 24. The control device 21 is a computer that performs information processing related to control of the vehicle VH based on various kinds of information. The control device 21 includes at least one processor 25 and at least one storage device 26. A configuration example of the processor 25 is the same as the configuration example of the processor 11 illustrated in FIG. 1. Further, a configuration example of the storage device 26 is the same as the configuration example of the storage device 12 illustrated in FIG. 1. The processor 25 implements information processing related to control of the vehicle VH in cooperation with the storage device 26.

For example, the control device 21 includes one or a plurality of electronic control units (ECUs). In another example, the control device 21 includes a kit (for example, an AVP kit) for functions to be provided by the parking server 10. The control device 21 generates a control signal of the vehicle VH through information processing and outputs the control signal. In a case where the vehicle VH receives an instruction INS of AVP operation (such as, for example, loading operation and unloading operation) from the parking server 10, the control device 21 generates a control signal CON for the AVP operation. The control signal CON is transmitted to the in-vehicle device 24.

The sensors 22 detect information of a peripheral environment and a traveling state of the vehicle VH. Examples of the sensors 22 can include a camera, a radar, a LiDAR, a wheel speed sensor, an inertial measurement unit (IMU) and a global navigation satellite system (GNSS) sensor.

The communication I/F 23 is an interface for communicating with a device outside the vehicle VH to transmit/receive information. The vehicle VH transmits/receives information to/from the parking server 10 via the communication I/F 23. The vehicle VH can also transmit/receive information to/from a user terminal 40 via the communication I/F 23.

The in-vehicle device 24 includes a lighting device, an in-vehicle illumination device, a horn, a direction indicator, a windshield wiper, a door, a door window, a mirror, a drive device, a braking device, a steering device, a human machine interface (HMI), and the like. Each device of the in-vehicle device 24 includes an actuator 27 that can be controlled by the control device 21. The in-vehicle device 24 acquires a control signal from the control device 21. As a result of the actuator 27 operating in accordance with the control signal, control of the in-vehicle device 24 is implemented by the control device 21. Further, control of the vehicle VH is implemented by control of the in-vehicle device 24. As a result of the actuator 27 operating in accordance with the control signal CON for the AVP operation, vehicle control for the AVP operation is implemented.

Returning to FIG. 1, description of the overall configuration example will be continued. FIG. 1 also illustrates the central server 30. The central server 30 is a server (cloud server) that manages the whole of the AVP service. The central server 30 manages a user (hereinafter, also referred to as an “AVP user”) who utilizes the AVP service, a vehicle (that is, the vehicle VH) including the vehicle system 20, and the like. Management of the AVP user includes authentication of the AVP user, management of reservation of the AVP by the AVP user, and the like. Management of the vehicle VH includes management of vehicle information of the vehicle VH, management of authority of operation of the vehicle VH, management of an AVP operation log of the vehicle VH, and the like.

The central server 30 is typically a computer including at least one processor 31, at least one storage device 32, and a communication I/F 33. A configuration example of the processor 31 is the same as the configuration example of the processor 11. Further, a configuration example of the storage device 32 is the same as the configuration example of the storage device 12.

Examples of various kinds of information stored in the storage device 32 can include AVP reservation information, user information, and AVP vehicle information. The AVP reservation information is information regarding reservation of the AVP by the AVP user. The AVP reservation information includes information on a parking area that is desired to be utilized by the AVP user, loading and unloading time, and the like. The user information includes information on a user ID of the AVP user, a vehicle ID of the vehicle to be utilized by the AVP user, and the like. The user information is managed for each AVP user. The AVP vehicle information includes information on the vehicle ID of the vehicle including the vehicle system 20, an IP address of the vehicle system 20, an AVP operation log by the vehicle system 20, and the like.

The communication I/F 33 is an interface for communicating with a device outside the central server 30 to transmit/receive information. For example, the communication I/F 33 includes equipment for connecting to a peripheral device through wireless LAN, equipment for connecting to a mobile communication network, equipment for connecting to the Internet, and the like. The central server 30 transmits/receives information to/from the parking server 10 via the communication I/F 33. The central server 30 also transmits/receives information to/from the user terminal 40 via the communication I/F 33.

The user terminal 40 is a terminal (for example, a smartphone) carried by the AVP user. The AVP user transmits/receives information to/from the vehicle VH (vehicle system 20) through operation of the user terminal 40. The AVP user also transmits/receives information to/from the central server 30 through operation of the user terminal 40. The user terminal 40 is used to register usage and reserve usage of the AVP service by the AVP user. The user terminal 40 is also used during the AVP in the parking area PK as appropriate.

Note that information regarding the AVP may be transmitted/received through operation of the in-vehicle device 24 (for example, an HMI) illustrated in FIG. 2 instead of operation of the user terminal 40.

### 2. Traveling Path and Traveling Plan

To execute the AVP (loading), for example, the parking server 10 transmits/receives information to/from the central server 30 to acquire authority of operation of the vehicle VH that is waiting in the pick-up and drop-off space PD. As a result of the authority of operation being transferred to the parking server 10, the parking server 10 (processor 11) can execute the AVP of the vehicle VH. The vehicle system 20 (processor 25) generates the control signal CON in accordance with the instruction INS of the AVP operation (loading operation) received from the parking server 10 and performs vehicle control for the AVP operation (loading operation) by controlling the in-vehicle device 24.

To implement the AVP (unloading), for example, the vehicle system 20 (processor 25) generates the control signal CON in accordance with the instruction INS of the AVP operation (unloading operation) received from the parking server 10 and performs vehicle control for the AVP operation (unloading operation) by controlling the in-vehicle device 24. When the vehicle VH arrives at the pick-up and drop-off space PD, the parking server 10 transmits/receives information to/from the central server 30 to return the authority of operation of the vehicle VH. As a result of the authority of operation being transferred to the central server 30, execution of the AVP of the vehicle VH by the parking server 10 (processor 11) ends.

The instruction INS of the AVP operation includes information on the traveling path PT. The traveling path PT is a set of path points PP within the parking area PK through which the vehicle VH should pass from a current place of the vehicle VH to a destination. The instruction INS is sequentially generated based on the information on the peripheral environment and the traveling state of the vehicle VH acquired from the sensors of the parking area PK. The information acquired from the sensors 22 of the vehicle VH may be used to generate the instruction INS. The generated instruction INS is sequentially transmitted to the vehicle VH from the parking server 10. The instruction INS transmitted at each timing includes information on the traveling path PT in a traveling direction of the vehicle VH.

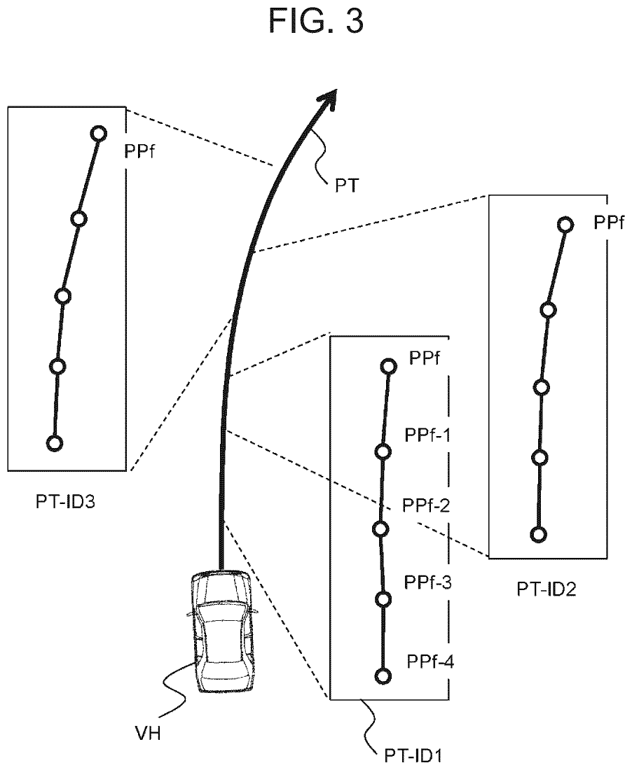

FIG. 3 is a view for explaining an example of the traveling path PT. FIG. 3 illustrates the traveling path PT ahead of the vehicle VH. The traveling path PT includes an interval path PT-ID1, an interval path PT-ID2, and an interval path PT-ID3. The interval paths PT-ID1, PT-ID2 and PT-ID3 are included in the instruction INS sequentially received by the vehicle VH (vehicle system 20) during the AVP operation and are identified by unique IDs provided for each interval path PT-IDK (k≥1).

The interval path PT-IDk includes a path point PP (hereinafter, also referred to as a “path end point PPf”) indicating an end point of the interval path PT-IDK. In the example illustrated in FIG. 3, the interval path PT-ID1 includes the path end point PPf, a path point PPf-1, a path point PPf-2, a path point PPf-3 and a path point PPf-4 before the path end point PPf. The path point PPf-4 can be also considered as a path point PP indicating a starting point of the interval path PT-ID1. Configurations of the path points PP of the interval paths PT-ID2 and PT-ID3 are basically the same as the configuration of the path points PP of the interval path point PT-ID1.

Each path point PP included in the interval path PT-IDK includes, for example, position information, rudder angle information, maximum speed information, and curvature information. The position information indicates a target position of the vehicle VH and is expressed by a two-dimensional coordinate (x, y) of the parking area PK. The rudder angle information indicates a target rudder angle of the vehicle VH at the path point PP. The maximum speed information indicates a permissible maximum speed of the vehicle VH at the path point PP. The curvature information indicates a curvature of the interval path PT-IDk.

The vehicle system 20 sets a traveling plan for following the interval path PT-IDk based on the information included in each path point PP of the interval path PT-IDK and information on the peripheral environment and the traveling state of the vehicle VH. The set traveling plan includes a speed plan and a rudder angle plan. The vehicle system 20 also performs vehicle control in accordance with the set traveling plan. Specifically, the vehicle system 20 calculates deviation (for example, speed deviation, lateral position deviation, yaw angle deviation) between the vehicle VH and the traveling plan, generates a control target value (for example, a target acceleration, a target rudder angle) such that the deviation decreases, and transmits the control signal CON to the actuator 27 (for example, a drive actuator, a braking actuator and a steering actuator). By this means, the AVP operation along the traveling path PT is performed.

### 3. Problem Near the Stop Position

The traveling plan is set based on the latest interval path of the vehicle system 20. For example, a case will be considered where the interval path PT-IDk is received from the parking server 10 during the AVP operation based on the traveling plan that follows the interval path PT-IDK-1. In this case, the vehicle system 20 sets a traveling plan that follows the interval path PT-IDk that is the latest interval path in consideration of the information on the peripheral environment and the traveling state of the vehicle VH and performs vehicle control for the AVP operation.

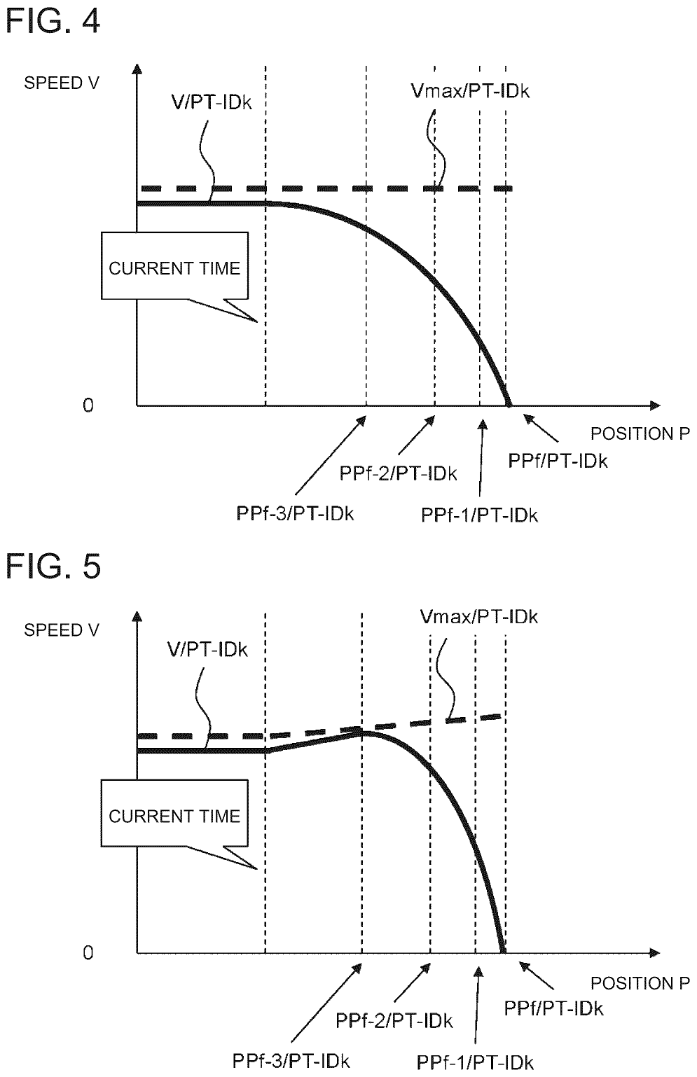

Here, a problem occurs when the position of the vehicle VH is near a stop position. FIG. 4 and FIG. 5 are views for explaining a problem near the stop position of the vehicle VH. FIG. 4 indicates an example of a speed plan V/PT-IDk that follows the interval path PT-IDk. The interval path PT-IDk is the latest interval path at current time. The interval path PT-IDk is, for example, an interval path when a target position (x, y) indicated by the path end point PPf corresponds to the final destination of the vehicle VH. In another example, the interval path PT-IDk is an interval path when the target position (x, y) indicated by the path end point PPf corresponds to a temporary stop position because of approach of a moving object to the vehicle VH.

It is assumed that the position (current position) of the vehicle VH at current time indicated in FIG. 4 is located before the target position (x, y) indicated by the path point PPf-3/PT-IDk. The speed plan V/PT-IDK is a plan of decelerating while the vehicle passes through the respective path points (path points PPf-3, PPf-2, PPf-1 and PPf) included in the interval path PT-IDk and stopping (speed V=0) at the path end point PPf/PT-IDk.

FIG. 4 also indicates a maximum speed Vmax/PT-IDk. The maximum speed Vmax/PT-IDk is obtained by linking permissible maximum speeds indicted by the respective path points (path points PPf, PPf-1, PPf-2, PPf-3, and the like) included in the interval path PT-IDK. In the example indicated in FIG. 4, the maximum speed Vmax/PT-IDK is constant, and the speed plan V/PT-ID is set so as not to exceed the maximum speed Vmax/PT-IDk.

In a similar manner to FIG. 4, FIG. 5 indicates the speed plan V/PT-IDk and the maximum speed Vmax/PT-IDK. Further, the path points PP (path points PPf, PPf-1, PPf-2, PPf-3) indicated in FIG. 5 are in common with the path points PP indicated in FIG. 4.

In the example indicated in FIG. 5, the permissible maximum speeds of the path points included in the interval path PT-IDK increase. Thus, the speed plan V/PT-IDK set in this example partially increases before the path end point PPf/PT-IDK. This constitutes an obstacle to accurate stop at the target position (x, y) indicated by the path end point PPf. Particularly, in a case where the target position (x, y) indicated by the path end point PPf corresponds to the final destination of the vehicle VH, there is a possibility that inaccurate stop of the vehicle VH at the final destination may force the vehicle VH to perform additional position adjustment.

### 4. Upper Limit Guard Processing

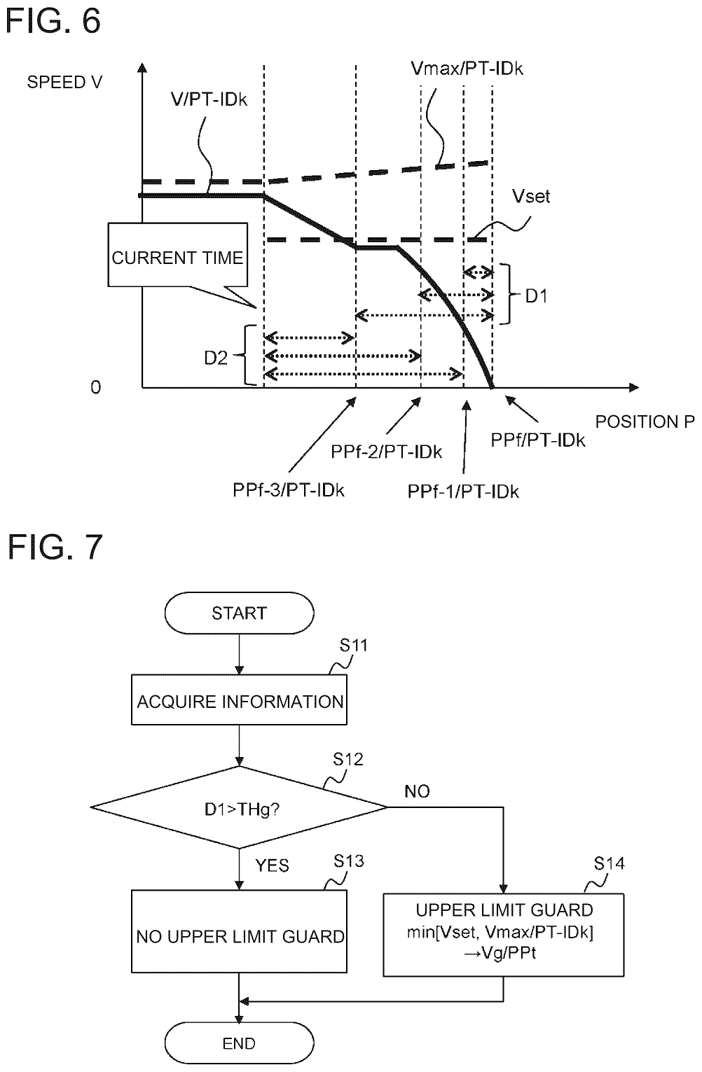

Thus, in the embodiment, processing (upper limit guard processing) of the vehicle system 20 applying an upper limit guard to the maximum speed Vmax is performed. FIG. 6 is a view for explaining the upper limit guard processing. In a similar manner to FIG. 5, FIG. 6 indicates the speed plan V/PT-IDk and the maximum speed Vmax/PT-IDk. Further, the maximum speed Vmax/PT-IDk indicated in FIG. 6 is the same as that indicated in FIG. 5. Still further, the path points PP (path points PPf, PPf-1, PPf-2, PPf-3) indicated in FIG. 6 are in common with the path points PP indicated in FIG. 5.

In the upper limit guard processing, first, each path point except the path end point PPf included in the interval path PT-IDK is extracted as a processing target. Hereinafter, the extracted path point PP that is the processing target will be also referred to as a “target path point PPt”. Subsequently, a guard threshold THg and a distance D1 between the target position (x, y) indicated by the target path point PPt and the target position (x, y) indicated by the path end point PPf are compared. The guard threshold THg is a value with which it can be determined that the target position (x, y) indicated by the target path point PPt is close to the target position (x, y) indicated by the path end point, that is, the former is close to the stop position. Further, in a case where the target path point PPt having the distance D1 equal to or less than the guard threshold THg is specified as a result of the comparison, the maximum speed Vmax indicated by this target path point PPt is replaced with an upper limit guard Vg/PPt indicated by the following equation (1).

$$Vg / PPt = min [ Vset , V max / PT - IDk ] \qquad ( 1 )$$

In equation (1), a value Vset is a guard speed set in advance. A value Vmax/PT-IDk is the maximum speed Vmax indicated by each path point included in the interval path PT-IDk. In other words, equation (1) means that a minimum value between the guard speed Vset and the maximum speed Vmax/PT-IDk is the upper limit guard Vg/PPt.

As a result of the upper limit guard processing being performed, it is possible to avoid occurrence of a failure in association with increase of the permissible maximum speed described in FIG. 5. In the example indicated in FIG. 6, the maximum speed Vmax indicated by the target path point PPt (path points PPf-3, PPf-2 and PPf-1) is replaced with the guard speed Vset as the upper limit guard Vg/PPt. This makes it possible to stop the vehicle VH at the target position (x, y) indicated by the path end point PPf.

By the way, there is a case where the vehicle system 20 receives an interval path PT-IDk+1 as the latest interval path from the parking server 10 during the AVP operation based on the traveling plan that follows the interval path PT-IDK. In this case, the vehicle system 20 sets a traveling plan for following the interval path PT-IDk+1 that is the latest interval path in consideration of the information on the peripheral environment and the traveling state of the vehicle VH. Then, the upper limit guard processing similar to the upper limit guard processing performed on the target path point PPt included in the interval path PT-IDk is performed on the target path point PPt included in the interval path PT-IDk+1.

However, there is a case where the maximum speed Vmax indicated by the target path point PPt included in the interval path PT-IDk is different from the maximum speed Vmax indicated by the target path point PPt included in the interval path PT-IDk+1. Thus, there is a possibility that as a result of the upper limit guard processing being performed although the position of the vehicle VH is close to the stop position, hunting may occur such that part of the speed plan V/PT-IDk+1 to which the upper limit guard Vg/PPt is applied exceeds the speed plan V/PT-IDK to which the upper limit guard Vg/PPt is applied as a result of the upper limit guard processing being performed.

Thus, in the embodiment, in a case where the vehicle system 20 receives the latest interval path (that is, the interval path PT-IDk+1) after setting of the speed plan V/PT-IDk to which the upper limit guard Vg/PPt is applied, the upper limit guard Vg/PPt applied in the upper limit guard processing of the target path point PPt included in the interval path PT-IDk may be referred to in the upper limit guard processing of the target path point PPt included in this latest interval path.

When the position of the vehicle VH is close to the stop position, it can be considered that a distance D2 from the position of the vehicle VH to the target position (x, y) indicated by the target path point PPt is short. Thus, a hunting threshold THh and the distance D2 (see FIG. 6) between the target position (x, y) indicated by the target path point PPt and the current position of the vehicle VH are compared. The hunting threshold THh is a value with which it can be determined that the target position (x, y) indicated by the target path point PPt is close to the current position of the vehicle VH. Then, in a case where the target path point PPt having the distance D2 equal to or less than the hunting threshold THh is specified as a result of the comparison, the maximum speed Vmax indicated by this target path point PPt is replaced with the upper limit guard Vg/PPt indicated in the following equation (2).

$$Vg / PPt = min [ Vset , V max / PT - IDk , Vg / PPt - 1 ] \qquad ( 2 )$$

In equation (2), a value Vg/PPt-1 is the upper limit guard with which the maximum speed Vmax indicated by the target path point PPt included in the previous interval path received before the latest interval path is replaced. In other words, equation (2) means that a minimum value among the guard speed Vset, the maximum speed Vmax/PT-IDK, and the previous upper limit guard Vg/PPt-1 is the upper limit guard Vg/PPt.

### 5. Information Processing Example

FIG. 7 is a flowchart indicating flow of information processing particularly related to the embodiment. Note that processing routine indicated in FIG. 7 is repeatedly executed at a predetermined period by the vehicle system 20 (processor 25).

In the processing routine indicated in FIG. 7, first, information is acquired (step S11). Examples of the information to be acquired in the processing in step S11 can include the instruction INS transmitted from the parking server 10, and the information on the peripheral environment and the traveling state of the vehicle VH acquired from the sensors 22. In the processing in step S11, information on the current position of the vehicle VH is also acquired. The current position of the vehicle VH is, for example, acquired through position estimation processing (localization processing) of the vehicle VH performed by the parking server 10 or the vehicle system 20.

Subsequent to the processing in step S11, it is determined whether or not the distance D1 exceeds the guard threshold THg (step S12). As described above, the distance D1 is a distance between the target position (x, y) indicated by the target path point PPt included in the interval path PT-IDk and the target position (x, y) indicated by the path end point PPf included in the interval path PT-IDK. The guard threshold THg is a value with which it can be determined that the target path point PPt is close to the stop position and is set in advance.

In a case where a positive determination result is obtained in step S12, it is determined that the target path point PPt is far from the stop position. Thus, in this case, the upper limit guard processing is not performed (step S13).

On the other hand, in a case where a negative determination result is obtained in step S12, it is determined that the target path point PPt is close to the stop position. Thus, in this case, the upper limit guard processing is performed (step S14). In the processing in step S14, the upper limit guard Vg/PPt is calculated using the above equation (1). Then, the maximum speed Vmax indicated by the target path point PPt is replaced with the upper limit guard Vg/PPt.

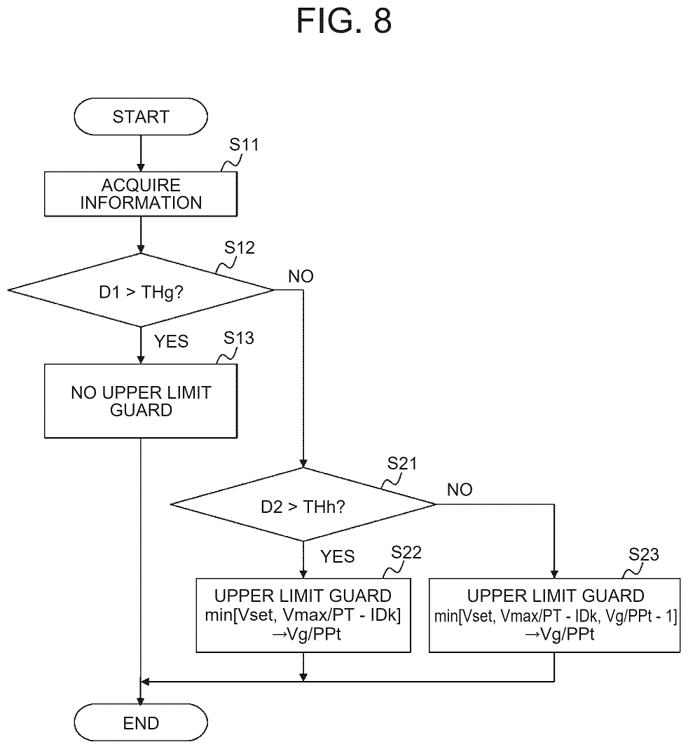

In a similar manner to FIG. 7, FIG. 8 is a flowchart indicating flow of information processing particularly related to the embodiment. Note that processing routine in FIG. 8 indicates a case where the previous upper limit guard Vg/PPt-1 is used to calculate the upper limit guard Vg/PPt. The processing routine indicated in FIG. 8 is repeatedly executed at a predetermined period by the vehicle system 20 (processor 25) instead of execution of the processing routine indicated in FIG. 7.

In the processing routine indicated in FIG. 8, in a case where a negative determination result is obtained in step S12, it is determined whether or not the distance D2 exceeds the hunting threshold THh (step S21). As described above, the distance D2 is a distance between the target position (x, y) indicated by the target path point PPt included in the interval path PT-IDk and the current position of the vehicle VH. The hunting threshold THh is a value with which it can be determined that the target path point PPt is close to the current position of the vehicle VH and is set in advance.

In a case where a positive determination result is obtained in step S21, it is determined that the target path point PPt is close to the stop position but far from the current position of the vehicle VH. Thus, in this case, the upper limit guard Vg/PPt is calculated using the above equation (1) (step S22). Then, the maximum speed Vmax indicated by the target path point PPt is replaced with the upper limit guard Vg/PPt. Note that the processing in step S22 is the same as the processing in step S14 in FIG. 7.

On the other hand, in a case where a negative determination result is obtained in step S12, it is determined that the target path point PPt is close to the stop position and is also close to the current position of the vehicle VH. Thus, in this case, the upper limit guard Vg/PPt is calculated using the above equation (2). Then, the maximum speed Vmax indicated by the target path point PPt is replaced with the upper limit guard Vg/PPt.

### 6. Effects

According to the embodiment described above, the upper limit guard processing is performed. Then, in a case where the distance D1 is determined to be equal to or less than the guard threshold THg, the maximum speed Vmax indicated by the target path point PPt is replaced with the upper limit guard Vg/PPt calculated using the above equation (1). It is therefore possible to prevent degradation of accuracy of stop of the vehicle VH at the path end point PPf. In a case where the target position (x, y) indicated by the path end point PPf is the final destination of the vehicle VH, it is also possible to prevent degradation of accuracy of stop of the vehicle VH at this final destination (the parking space PS upon loading, the pick-up and drop-off space PD upon unloading).

Further, according to the embodiment, in a case where the distance D2 is determined to be equal to or less than the hunting threshold THh, the maximum speed Vmax indicated by the target path point PPt is replaced with the upper limit guard Vg/PPt calculated using the above equation (2). It is therefore possible to prevent degradation of accuracy of stop of the vehicle VH at the path end point PPf while preventing hunting of the speed plan after the upper limit guard Vg/PPt being applied as a result of the upper limit guard processing being performed.

What is claimed is:

1. A system that performs automated valet parking of a vehicle within a predetermined area, the system comprising:
a management device configured to manage the automated valet parking; and
a control device mounted on the vehicle and configured to perform vehicle control for the automated valet parking based on a traveling path received from the management device, wherein:
the traveling path includes a plurality of path points;
each of the plurality of path points includes information on a target position of the vehicle, and information on a maximum speed of the vehicle;
the vehicle control includes processing of applying an upper limit guard to a maximum speed of a target path point based on information on a target position of a path end point and information on a target position of the target path point;
the path end point is included in the plurality of path points and indicates an end point of the traveling path;
the target path point is included in the plurality of path points; and
the processing of applying the upper limit guard includes:
processing of determining whether or not a first distance from the target position of the target path point to the target position of the path end point is equal to or less than a guard threshold; and
processing of replacing, by using a minimum speed between a guard speed set in advance and the maximum speed included in each of the plurality of path points, the maximum speed of the target path point in a case where the first distance is determined to be equal to or less than the guard threshold.

2. The system according to claim 1, wherein:
the processing of applying the upper limit guard is performed on the target path point included in a latest traveling path received from the management device;
the processing of applying the upper limit guard further includes processing of determining whether or not a second distance from a current position of the vehicle to the target position of the target path point is equal to or less than a hunting threshold; and
in a case where the second distance is determined to be equal to or less than the hunting threshold, in the processing of replacing the maximum speed of the target path point, the maximum speed of the target path point is replaced by using a minimum speed among the guard speed, the maximum speed included in each of the plurality of path points, and the upper limit guard used to replace the maximum speed of the target path point included in a previous traveling path received from the management device before the latest traveling path is received.

3. The system according to claim 1, wherein the target position of the path end point includes a final destination of the vehicle within the predetermined area.

4. A method for performing automated valet parking of a vehicle within a predetermined area, the method comprising:
receiving, by a control device of the vehicle, a traveling path from a management device configured to manage the automated valet parking; and
performing, by the control device, vehicle control for the automated valet parking based on the traveling path, wherein:
the traveling path includes a plurality of path points;
each of the plurality of path points includes information on a target position of the vehicle and information on a maximum speed of the vehicle;
the vehicle control includes application of an upper limit guard to a maximum speed of a target path point based on information on a target position of a path end point and information on a target position of the target path point;
the path end point is included in the plurality of path points and indicates an end point of the traveling path;
the target path point is included in the plurality of path points; and
the application of the upper limit guard includes:
determining whether or not a first distance from the target position of the target path point to the target position of the path end point is equal to or less than a guard threshold; and
replacing, by using a minimum speed between a guard speed set in advance and the maximum speed included in each of the plurality of path points, the maximum speed of the target path point in a case where the first distance is determined to be equal to or less than the guard threshold.

5. The method according to claim 4, wherein:
the application of the upper limit guard is performed on the target path point included in a latest traveling path received from the management device;
the application of the upper limit guard further includes determining whether or not a second distance from a current position of the vehicle to the target position of the target path point is equal to or less than a hunting threshold; and
in a case where the second distance is determined to be equal to or less than the hunting threshold, in replacing the maximum speed of the target path point, the maximum speed of the target path point is replaced using a minimum speed among the guard speed, the maximum speed included in each of the plurality of path points, and the upper limit guard used to replace the maximum speed of the target path point included in a previous traveling path received from the management device before the latest traveling path is received.

6. The method according to claim 4, wherein the target position of the path end point includes a final destination of the vehicle within the predetermined area.
